(19) United States
(12) Patent Application Publication
(10) Pub. No.: US 2025/0317248 A1
(43) Pub. Date: Oct. 9, 2025

(54) Methods For Transmitting Reference Signal Associated With Unlicensed Band In Mobile Communications

(71) Applicant: MediaTek Inc., Hsinchu City (TW)

(72) Inventors: Lung-Sheng Tsai, Hsinchu City (TW); Chun-Hao Fang, Hsinchu City (TW)

(21) Appl. No.: 19/087,705

(22) Filed: Mar. 24, 2025

Related U.S. Application Data
(60) Provisional application No. 63/573,587, filed on Apr. 3, 2024.

(51) Int. Cl. H04L 5/00; H04W 40/04

(52) U.S. Cl. CPC H04L 5/0048; H04W 40/04

(57) ABSTRACT

Various solutions for transmitting reference signal associated with unlicensed band with respect to an apparatus in mobile communications are described. The apparatus may determine a group of resource block (RB) sets in an unlicensed band. The apparatus may transmit a first reference signal in a licensed band. The apparatus may transmit a second reference signal in the group of RB sets. The first reference signal may be associated with the second reference signal.

### CROSS REFERENCE TO RELATED PATENT APPLICATION(S)

The present disclosure is part of a non-provisional application claiming the priority benefits of U.S. Patent Application No. 63/573,587, filed on 3 Apr. 2024, the content of which herein being incorporated by reference in its entirety.

### TECHNICAL FIELD

The present disclosure is generally related to mobile communications and, more particularly, to transmitting reference signal associated with unlicensed band with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communication systems, a collaborative device may be deployed to enhance communication flexibility and robustness. In particular, a network node may connect to a user equipment (UE) and the collaborative device over a licensed band. The collaborative device may connect to the UE over an unlicensed band. Based on this architecture, the UE may transmit a signal (e.g., reference signal) to the network node via a direct path (i.e., to the network node over the licensed band) and an indirect path (i.e., via the collaborative device over the unlicensed band) for the network node to estimate channel quality.

However, to access the unlicensed band as communication channel between the UE and the collaborative device, uncertainty may exist on the availability of the local-link channel (i.e., the channel between the UE and the collaborative device). In certain scenarios, the acquisition of channel state information (CSI) may be impeded when reference signal(s) is (are) unable to traverse the unlicensed band due to a channel sensing procedure failure, which may significantly reduce the overall network efficiency.

Accordingly, how to prevent the acquisition of CSI from being impeded becomes important issues in the newly developed wireless communication network, and there is an urgent need to provide proper schemes to transmit reference signal associated with the unlicensed band.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to transmitting reference signal associated with unlicensed band with respect to apparatus in mobile communications.

In one aspect, a method may involve an apparatus determining a group of resource block (RB) set in an unlicensed band. The method may also involve the apparatus transmitting a first reference signal in a licensed band. The method may further involve the apparatus transmitting a second reference signal in the group of RB set. The first reference signal may be associated with the second reference signal.

In one aspect, a method may involve an apparatus receiving a first reference signal from a first device in a licensed band. The method may also involve the apparatus receiving a second reference signal from a second device in the licensed band. The second signal may be forwarded via a group of RB set of an unlicensed band, and the first reference signal may be associated with the second reference signal.

In one aspect, a method may involve an apparatus receiving a reference signal in a licensed band. The method may also involve the apparatus transforming the reference signal into another reference signal. The method may further involve the apparatus transmitting the another reference signal in a licensed band.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIGS. 2A to 2G are diagrams depicting example scenarios under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmitting reference signal associated with unlicensed band in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may wirelessly connect to a user equipment (UE) and a collaborative device over a licensed band. The UE and the collaborative device may connect with each other over an unlicensed band. The UE and the collaborative device may communicate with each other via a group of resource block (RB) set of the unlicensed band. The UE may transmit reference signal(s) (RS(s)) to the network node via: (1) a direct path between the UE and the network node, and (2) an indirect path between the collaborative device and the UE.

Accordingly, the network node may measure the RS(s) transmitted via the direct path and the indirect path. The network node may then determine a CSI based on measuring the RS(s) over the licensed band.

In the present disclosure, the RS(s) transmitted via the indirect path (e.g., via the licensed band and the unlicensed band) may be estimated regardless of whether all sensing procedures associated with the group of RB set of the unlicensed band between the UE and the collaborative device are successful, thereby the network node may determine the CSI associated with at least one of the licensed band and the unlicensed band without any impediment.

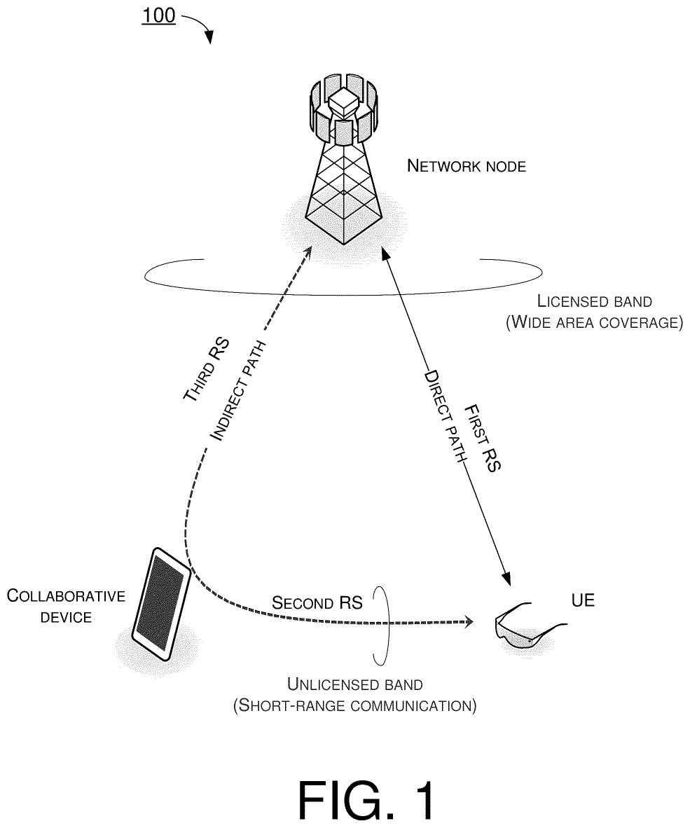

FIG. 1 illustrates an example scenario 100 under schemes in accordance with implementations of the present disclosure. Scenario 100 involves at least one network node, a UE and a collaborative device, which may be a part of a wireless communication network (e.g., an LTE network, a 5G/NR network, an IoT network or a 6G network).

Scenario 100 illustrates the current network framework. The network node may wirelessly connect to the UE and the collaborative device over a licensed band. In other words, the UE and the collaborative may camp on the same network node which may provide a wide area coverage for long-range communication. The UE and the collaborative device may connect with each other over an unlicensed band. In other words, the UE and the collaborative device may establish a short-range wireless connection with each other to perform a short-range communication over the unlicensed band. It should be noted that in the figures of the present application, the UE may be exemplified as a smart device, and the collaborative device may be exemplified as a smart phone. However, this is for illustrative purposes and not intended to be limiting.

In some embodiments, the UE and/or the collaborative device may determine a group of RB sets in the unlicensed band for communicating with each other. The UE may transmit a first RS (e.g., sounding reference signal (SRS)) to the network node in the licensed band and transmit a second RS (e.g., SRS) to the network node via the collaborative device. More specifically, the UE may transmit the second RS to the collaborative device in the group RB sets of the unlicensed band. After receiving the second RS, the collaborative device may transform the second RS and transmit (i.e., forward) the transformed second RS to the network node. The transformed second RS may be denoted by a third RS. The transforming may include “amplifying and forwarding” with frequency translation, and the second RS and the third RS are corresponding to identical baseband RS signal.

In some implementations, the UE and/or the collaborative device may determine the group of RB sets from a plurality of RB sets in the unlicensed band by performing a plurality of channel sensing procedures in the plurality of RB sets. It should be noted that, in the following descriptions, “RB set(s) passing sensing procedure(s)” may represent that the collaborative device and/or the UE successfully perform a sensing procedure over the corresponding RB set (i.e., the collaborative device and/or the UE occupy RB set(s) and are capable of transmitting signal over the occupied RB set(s)).

In some cases, the group of RB sets may be empty in an event that one RB set of the plurality of RB sets fails a corresponding sensing procedure. In particular, for each RB set of the plurality of RB sets in the unlicensed band, the UE and/or the collaborative device may perform a corresponding sensing procedure (e.g., Listen-Before-Talk (LBT) procedure). In an event that any RB set does not pass the corresponding procedure, the group of RB sets may be determined to be empty.

In some cases, each RB set in the group of RB sets may be associated with a successful sensing procedure. In particular, for each RB set of the plurality of RB sets in the unlicensed band, the UE and/or the collaborative device may perform a corresponding sensing procedure (e.g., LBT procedure). In an event that an RB set passes the corresponding sensing procedure, the RB set may be added to the group of RB sets. In an event that an RB set does not pass the corresponding sensing procedure, the RB set may not be added to the group of RB sets. In brief, each RB set in the group of RB sets passes the corresponding sensing procedure.

After receiving the first RS via the direct path (i.e., from the UE in the licensed band) and the second RS via the indirect path (i.e., from the collaborative device in the licensed band while the second RS may be transmitted from the UE via a group of RB sets of the unlicensed band and be forwarded by the collaborative device into the licensed band as the third RS), the network node may measure the first RS and the second RS. The forwarding may include “amplifying and forwarding” with frequency translation, and the second RS and the third RS may correspond to identical baseband RS signal. Then, the network node may determine an end-to-end CSI corresponding to an end-to-end channel between the UE and the network node based on measuring the first RS and the third RS.

In some implementations, after determining the group of RB sets from the plurality of RB sets in the unlicensed band by performing the plurality of sensing procedures in the plurality of RB sets, the UE and/or the collaborative device may determine related information and transmit the related information to the network node. In particular, the related information may include at least one of the following: (1) information of sensing procedure result for the plurality of RB sets; (2) information of successfully sensing procedure; and (3) information of power for energy detection.

In some cases, the information of sensing procedure result for the plurality of RB sets may include quantity reporting sensing procedure result for the plurality of RB sets in the unlicensed band. For example, in an event that two RB sets pass the corresponding sensing procedures (e.g., LBT procedures), the information includes ‘2’.

In some cases, information of successfully sensing procedure may include a quantity reflecting probability of successfully sensing procedure. For example, the quantity is a probability of successful sensing procedure (e.g., LBT procedure) rate. For another example, the quantity is a probability is a ratio of unavailable probability to successful probability for channel access.

In some cases, the information of received for energy detection may include observed power or energy for energy detection.

In some implementations, the first RS may be associated with the second RS. In some cases, the first RS and the second RS may be transmitted by the UE and the collaborative device in a same time slot. In other words, the first RS and the third RS may be received by the network node in a same time slot.

In some implementations, the first RS and the second RS may be associated with a multi-port SRS. Or equivalently, the first RS and the third RS may be associated with a multi-port SRS. In particular, the first RS may be associated with a first port number. The second RS may be associated with a second port number. The multi-port SRS may be associated with a third port number. A sum of the first port number and the second port number may be equal to the third port number. For example, the first RS and the second RS are associated with an N-port SRS. The first RS corresponds to ‘M’ out of ‘N’ ports. The second RS corresponds to the rest port(s) which are (N-M) port(s). ‘N’ and ‘M’ are positive integers.

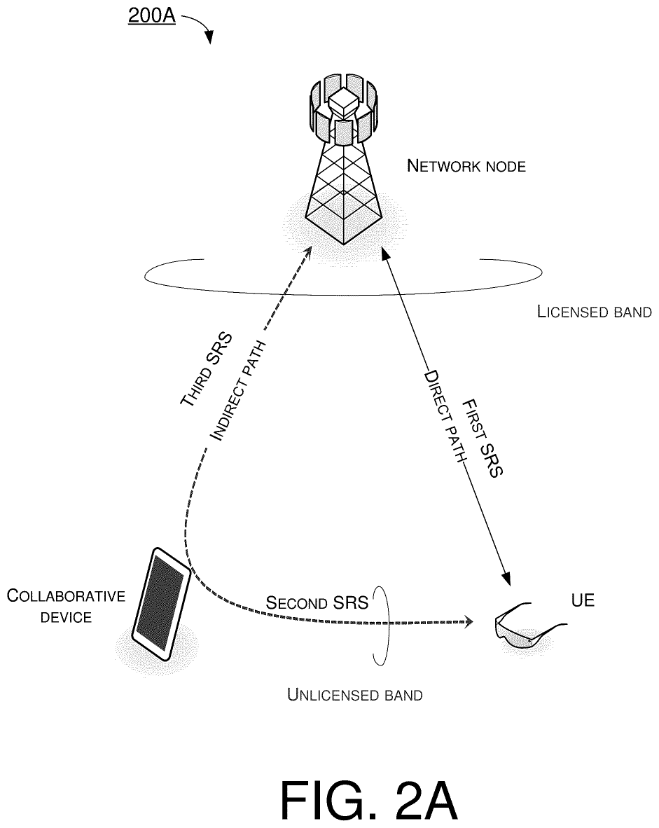

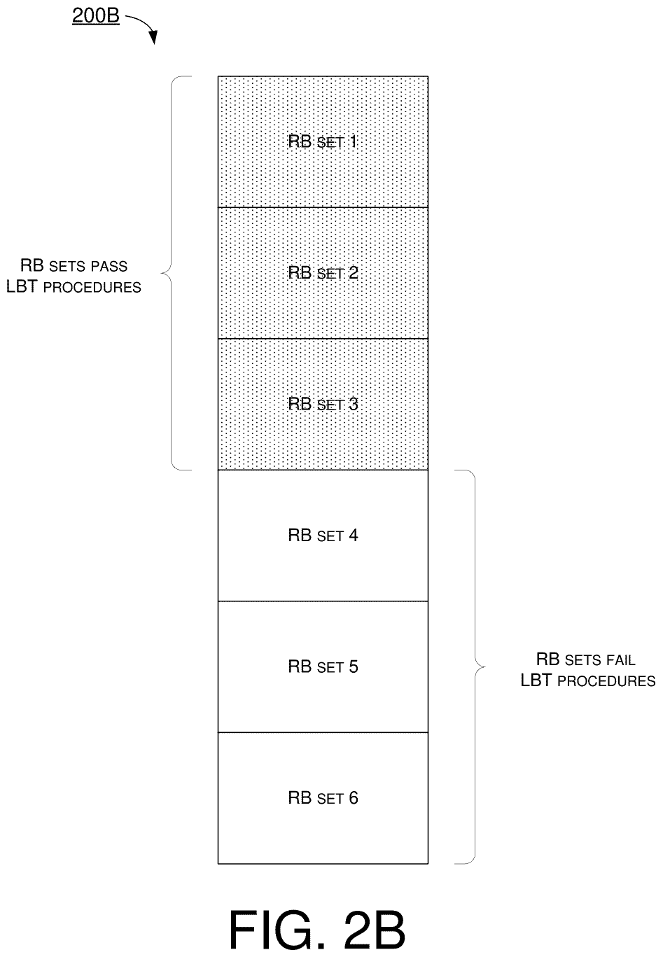

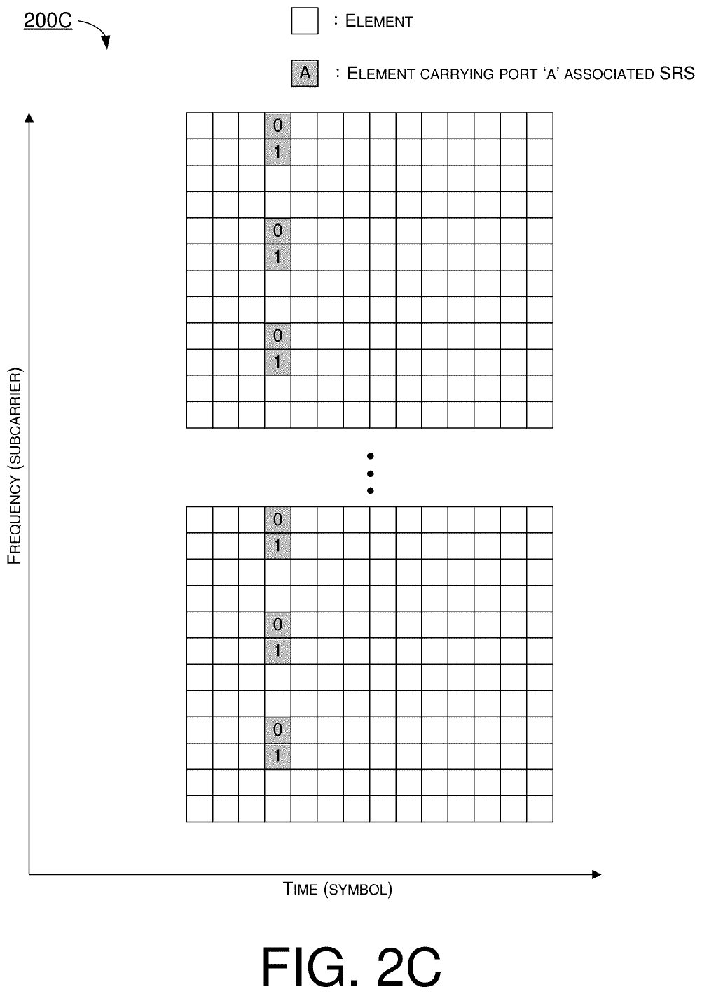

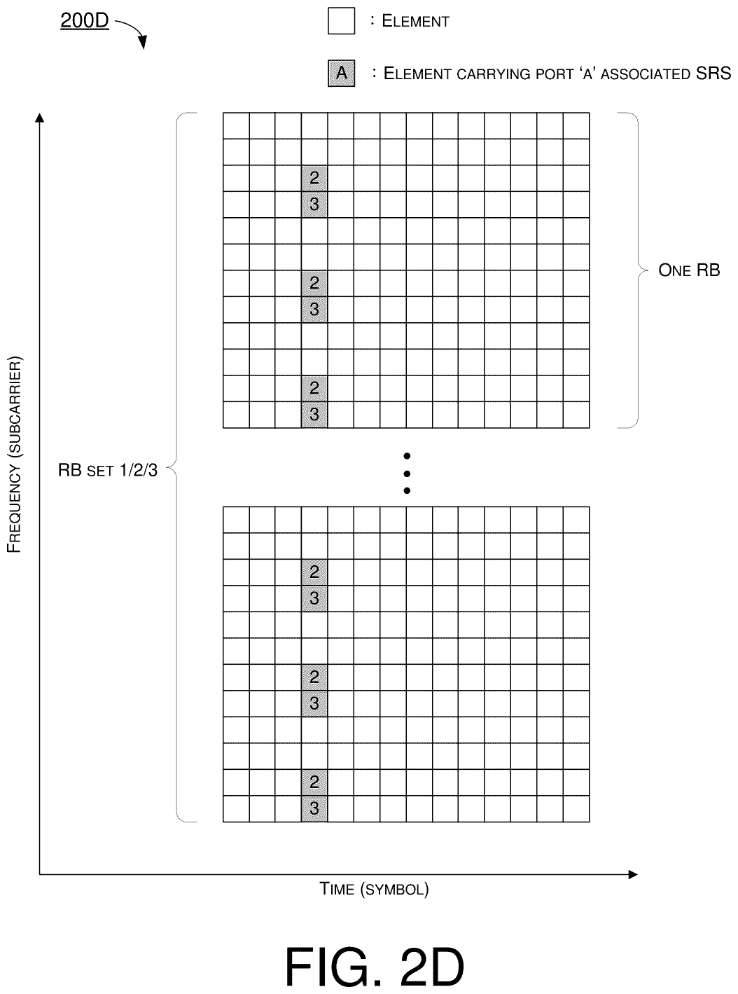

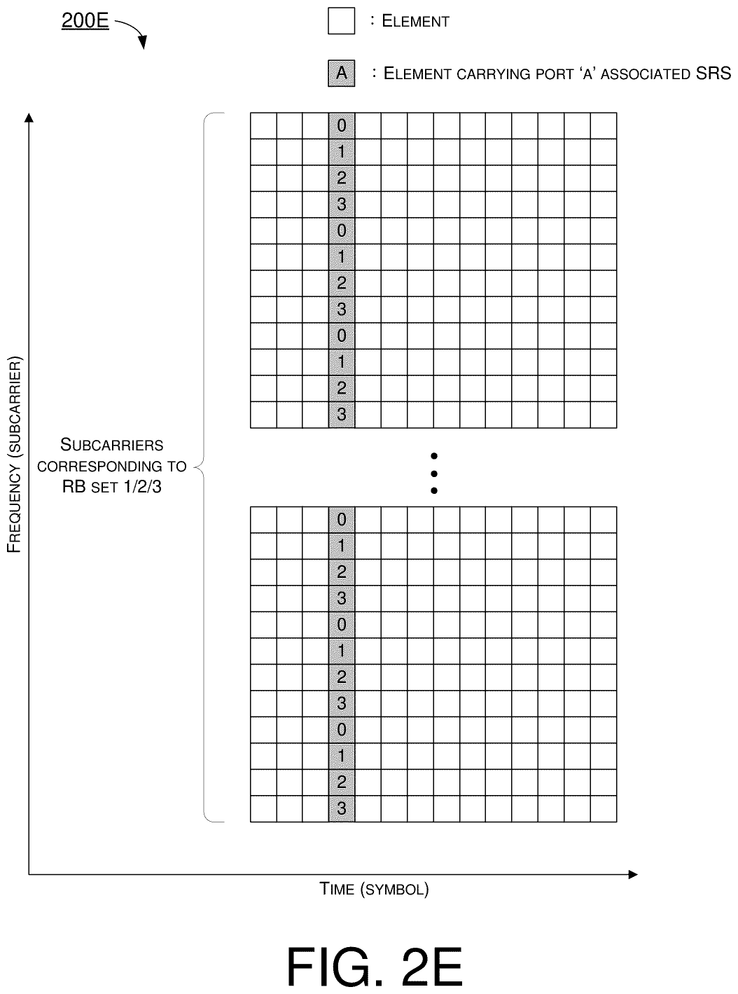

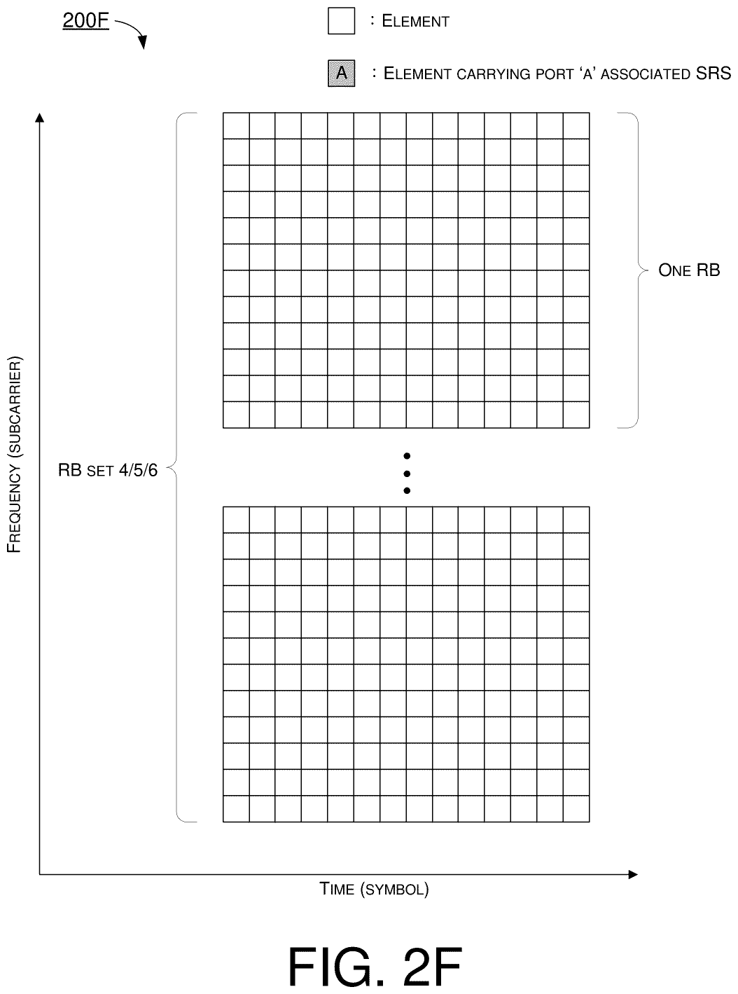

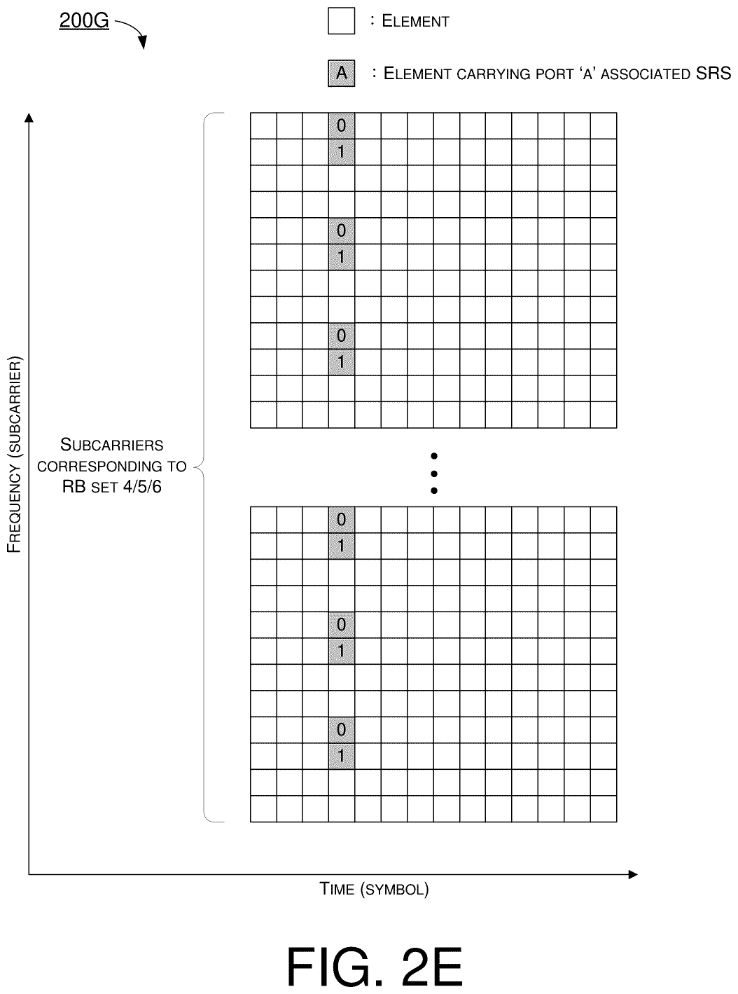

FIGS. 2A to 2G illustrate example scenario 200A to 200G under schemes in accordance with implementations of the present disclosure. FIG. 2A depicts a scenario 200A of SRSs transmission. FIG. 2B depicts an example 200B of RB sets 1 to 6 utilized under an unlicensed band between the UE and the collaborative device while RB sets 1 to 3 pass LBT procedures and RB sets 4 to 6 fail LBT procedures. FIG. 2C depicts an example 200C of a transmission of a first SRS between the UE and the network node under a licensed band. FIG. 2D depicts an example 200D of a transmission of a second SRS via each RB set which passes the LBT procedure (i.e., each of RB sets 1 to 3) between the UE and the collaborative device under the unlicensed band. FIG. 2E depicts an example 200E of a joint reception of the first SRS and a third SRS at the network node end under the licensed band while the third SRS is transformed from the second SRS transmitted via each of RB sets 1 to 3. FIG. 2F depicts an example 200F of non-transmission of the second SRS via each RB set which fails the LBT procedure (i.e., each of RB sets 4 to 6) between the UE and the collaborative device under the unlicensed band. FIG. 2G depicts an example 200G of a reception of the first SRS at the network node end under the licensed band with respect to the non-transmission of the second SRS.

More specifically, the unlicensed band between the UE and the collaborative device includes multiple RB sets which are RB set 1 to RB set 6. The UE and/or the collaborative device perform an LBT procedure for each RB set. In this example, as shown in FIG. 2B, LBT procedures for the RB sets 1 to 3 are all successful (RB sets with dotted background), which means that occupancies of the RB sets 1 to 3 are obtained by the collaborative device and/or the UE for transmitting signal. LBT procedures for the rest RB sets are failed (RB sets with white background), which means that occupancies of the rest RB sets are not obtained by the collaborative device and/or the UE for transmitting signal. Therefore, the UE and/or the collaborative device determine a first group of RB sets including RB sets 1 to 3 with successful LBT procedure for communicating with each other in the unlicensed band. The UE and/or the collaborative device determine a second group of RB sets including RB sets 4 to 6 with failed LBT procedure.

In some scenarios, the UE transmits 4-port associated SRSs to the network node. In particular, the UE transmits the first SRS associated with port 0 and port 1 to the network node via the direct path. As shown in FIG. 2C, there are corresponding resource elements (REs). The first SRS associated with port 0 and port 1 are carried by the elements (element with grey background) shown in FIG. 2C.

Further, the UE transmits the second SRS associated with port 2 and port 3 to the network node via the indirect path which is through the collaborative device. In particular, the second SRS is transmitted from the UE to the collaborative device via the first group of RB sets first. As shown in FIG. 2D, each RB set of RB sets 1 to 3 has 20 MHz bandwidth and 14 symbols while one RB has 12 subcarriers and 14 symbols. The second SRS associated with port 2 and port 3 are carried by the elements (element with grey background) shown in FIG. 2C.

Then, the collaborative device transforms the second SRS received in the first group of RB sets to the third SRS by performing frequency translation (from the unlicensed band to the licensed band) and, if necessary, applying amplify-and-forward processing. Next, the collaborative device transmits the third SRS to the network node in the licensed band, which is transformed from the first group of RB sets. The first SRS and the second SRS are transmitted in same time slot. Accordingly, the network node receives the first SRS and the third SRS in same time slot.

Regarding the second group RB sets including RB sets 4 to 6 which fail the LBT procedures, the UE does not transmit the second SRS associated with port 2 and port 3 to the collaborative device as shown in FIG. 2F so that the second SRS is not forwarded by the collaborative device. Therefore, the collaborative device does not transmit any possible third signal to the network node in the licensed band. Accordingly, the network node receives the first SRS only as shown in FIG. 2G.

It should be noted that, as another example, a group of RB sets is determined to be empty in an event that any RB set fails corresponding LBT procedure. More specifically, regarding RB sets ‘1’ to ‘6’, if any of RB sets ‘1’ to ‘6’ fails corresponding LBT procedure, the group of RB sets for transmitting the second SRS is determined to be empty. In other words, the UE does not transmit the second RS in the unlicensed band, and the second RS is not forwarded by the collaborative device.

### Illustrative Implementations

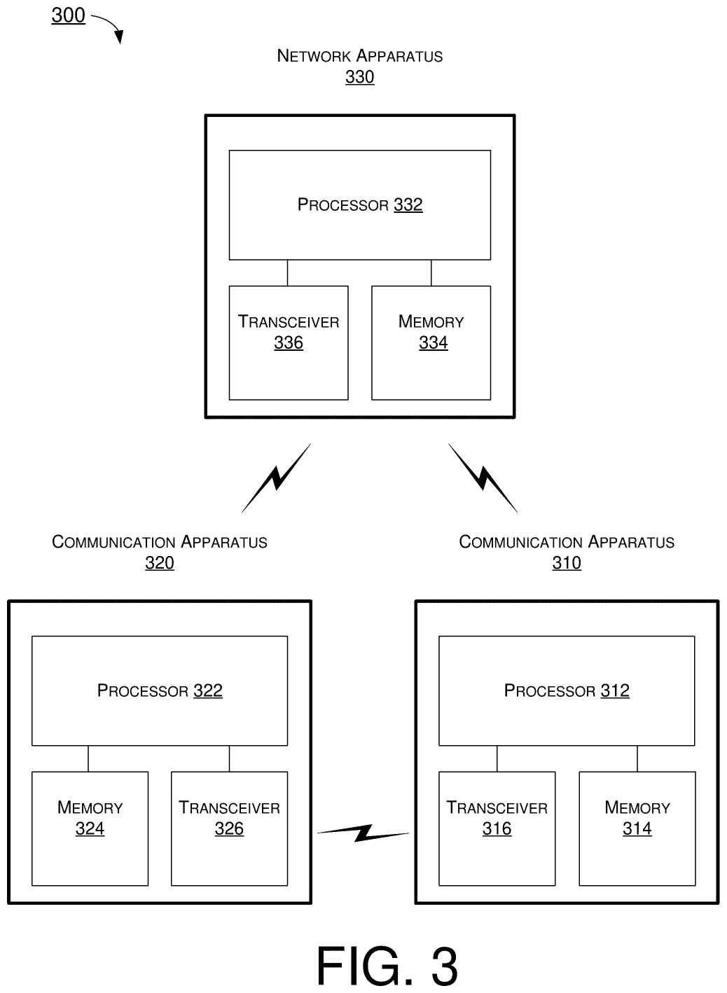

FIG. 3 illustrates an example communication system 300 having an example communication apparatus 310, an example communication apparatus 320, and an example network apparatus 330 in accordance with an implementation of the present disclosure. Each of communication apparatus 310, communication apparatus 320 and network apparatus 330 may perform various functions to implement schemes, techniques, processes and methods described herein pertaining to transmitting RS associated with unlicensed band in mobile communications, including scenarios/schemes described above as well as process 400, process 500 and process 600 described below.

Communication apparatus 310/320 may be a part of an electronic apparatus, which may be a UE such as a portable or mobile apparatus, a wearable apparatus, a mobile communication apparatus or a computing apparatus. For instance, communication apparatus 310/320 may be implemented in a smartphone, a smartwatch, a personal digital assistant, a digital camera, or a computing equipment such as a tablet computer, a laptop computer or a notebook computer. Communication apparatus 310/320 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310/320 may be implemented in a smart thermostat, a smart fridge, a smart door lock, a wireless speaker or a home control center. Alternatively, communication apparatus 310/320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310/320 may include at least some of those components shown in FIG. 3 such as a processor 312/322, for example. Communication apparatus 310/320 may further include one or more other components not pertinent to the proposed scheme of the present disclosure (e.g., internal power supply, display device and/or user interface device), and, thus, such component(s) of communication apparatus 310/320 are neither shown in FIG. 3 nor described below in the interest of simplicity and brevity.

Network apparatus 330 may be a part of a network device, which may be a network node such as a satellite, a base station, a small cell, a router or a gateway. For instance, network apparatus 330 may be implemented in an eNodeB in an LTE network, in a gNB in a 5G/NR, IoT, NB-IoT or IIoT network or in a satellite or base station in a 6G network. Alternatively, network apparatus 330 may be implemented in the form of one or more IC chips such as, for example and without limitation, one or more single-core processors, one or more multi-core processors, or one or more RISC or CISC processors. Network apparatus 330 may include at least some of those components shown in FIG. 3 such as a processor 332, for example. Network apparatus 330 may further include one or more other components not pertinent to the proposed scheme of the present disclosure (e.g., internal power supply, display device and/or user interface device), and, thus, such component(s) of network apparatus 330 are neither shown in FIG. 3 nor described below in the interest of simplicity and brevity.

In one aspect, each of processor 312, processor 322 and processor 332 may be implemented in the form of one or more single-core processors, one or more multi-core processors, or one or more CISC processors. That is, even though a singular term “a processor” is used herein to refer to processor 312, processor 322 and processor 332, each of processor 312, processor 322 and processor 332 may include multiple processors in some implementations and a single processor in other implementations in accordance with the present disclosure. In another aspect, each of processor 312, processor 322 and processor 332 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312, processor 322 and processor 332 is a special-purpose machine specifically designed, arranged and configured to perform specific tasks including transmitting RS associated with unlicensed band in a device (e.g., as represented by communication apparatus 310 and communication apparatus 320) and a network (e.g., as represented by network apparatus 330) in accordance with various implementations of the present disclosure.

In some implementations, communication apparatus 310 may also include a transceiver 316 coupled to processor 312 and capable of wirelessly transmitting and receiving data. In other words, processor 312 may transceive the data such as configuration, message, signal, information, indicator, etc. via transceiver 316. In some implementations, communication apparatus 310 may further include a memory 314 coupled to processor 312 and capable of being accessed by processor 312 and storing data therein. In some implementations, communication apparatus 320 may also include a transceiver 326 coupled to processor 322 and capable of wirelessly transmitting and receiving data. In other words, processor 322 may transceive the data such as configuration, message, signal, information, indicator, etc. via transceiver 326. In some implementations, communication apparatus 320 may further include a memory 324 coupled to processor 322 and capable of being accessed by processor 322 and storing data therein. In some implementations, network apparatus 330 may also include a transceiver 336 coupled to processor 332 and capable of wirelessly transmitting and receiving data. In other words, processor 332 may transceive the data such as configuration, message, signal, information, indicator, etc. via transceiver 336. In some implementations, network apparatus 330 may further include a memory 334 coupled to processor 332 and capable of being accessed by processor 332 and storing data therein. Accordingly, communication apparatus 310, communication apparatus 320 and network apparatus 330 may wirelessly communicate with each other via transceiver 316, transceiver 326 and transceiver 336, respectively. To aid better understanding, the following description of the operations, functionalities and capabilities of each of communication apparatus 310, 320 and network apparatus 330 is provided in the context of a mobile communication environment in which communication apparatus 310, 320 are implemented in or as a communication apparatus or a UE and network apparatus 330 is implemented in or as a network node of a communication network.

In some implementations, each of memory 314, 324 and 334 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314, 324 and 334 may include a type of read-only memory (ROM) such as mask ROM, programmable ROM (PROM), erasable programmable ROM (EPROM) and/or electrically erasable programmable ROM (EEPROM). Alternatively, or additionally, each of memory 314, 324 and 334 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

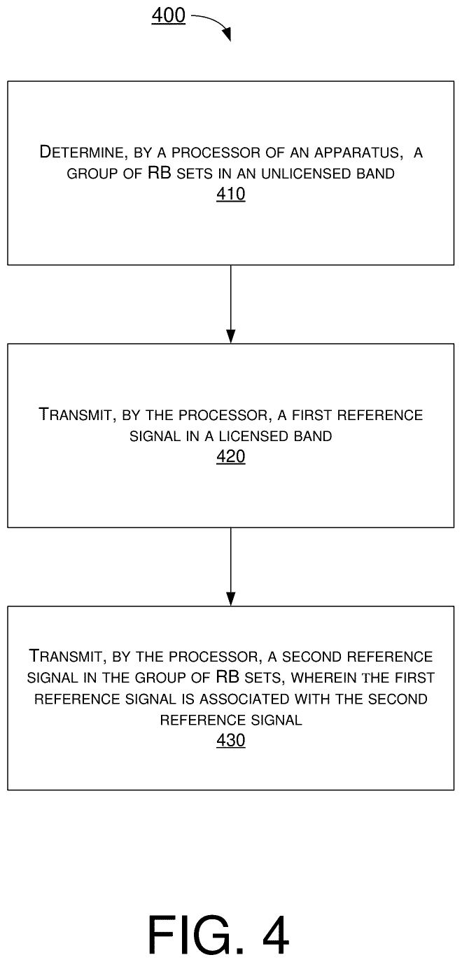

FIG. 4 illustrates an example process 400 in accordance with an implementation of the present disclosure. Process 400 may be an example implementation of above scenarios/schemes, whether partially or completely, with respect to transmitting RS associated with unlicensed band in mobile communications of the present disclosure. Process 400 may represent an aspect of implementation of features of communication apparatus 310. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable communication device or machine type devices. Solely for illustrative purposes and without limitation, process 400 is described below in the context of communication apparatus 310. Process 400 may begin at block 410.

At block 410, process 400 may involve processor 312 of communication apparatus 310 determining a group of RB sets in an unlicensed band. Process 400 may proceed from block 410 to block 420.

At block 420, process 400 may involve processor 312 transmitting a first reference signal in a licensed band. Process 400 may proceed from block 420 to block 430.

At block 430, process 400 may involve processor 312 transmitting a second reference signal in the group of RB sets. The first reference signal may be associated with the second reference signal.

In some implementations, process 400 may further involve processor 312 determining the group of RB sets from a plurality of RB sets in the unlicensed band by performing a plurality of sensing procedures in the plurality of RB sets.

In some implementations, the group of RB sets may be determined to be empty in an event that at least one RB set of the plurality of RB sets fails a corresponding sensing procedure.

In some implementations, process 400 may further involve processor 312 transmitting at least one of: (1) information of sensing procedure result for the plurality of RB sets: (2) information of successful sensing procedure; and (3) information of power for energy detection.

In some implementations, the first reference signal and the second reference signal may be transmitted in a same time slot.

In some implementations, the first reference signal and the second reference signal may be associated with a multi-port sounding reference signal.

In some implementations, the first reference signal may be associated with a first port number. The second reference signal may be associated with a second port number. The multi-port sounding reference signal may be associated with a third port number. A sum of the first port number and the second port number may be equal to the third port number.

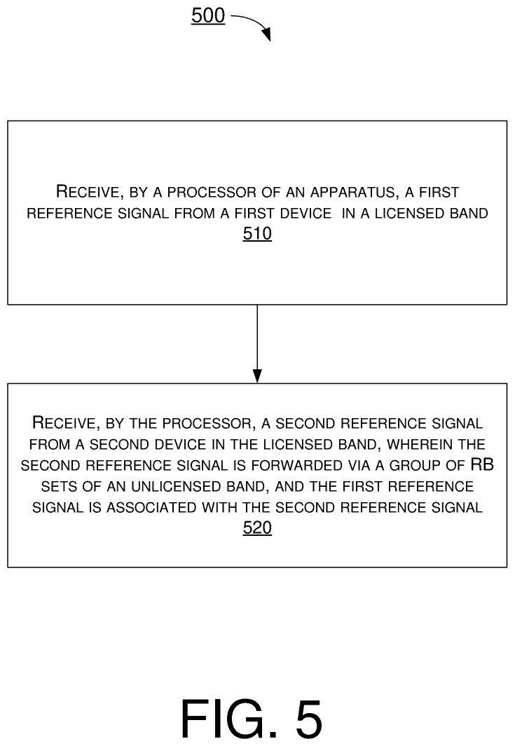

FIG. 5 illustrates an example process 500 in accordance with an implementation of the present disclosure. Process 500 may be an example implementation of above scenarios/schemes, whether partially or completely, with respect to transmitting RS associated with unlicensed band in mobile communications of the present disclosure. Process 500 may represent an aspect of implementation of features of network apparatus 330. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 330 or any suitable network device or machine type devices. Solely for illustrative purposes and without limitation, process 500 is described below in the context of network apparatus 330. Process 500 may begin at block 510.

At block 510, process 500 may involve processor 332 of network apparatus 330 receiving a first reference signal from a first device in a licensed band. The first reference signal may be transformed into a second reference signal. Process 500 may proceed from block 510 to block 520.

At block 520, process 500 may involve processor 332 receiving a second reference signal from a second device in the licensed band. The second reference signal may be transmitted from the first device via a group of RB sets of an unlicensed band and forwarded from the second device in the licensed band. The first reference signal may be associated with the second reference signal.

In some implementations, the group of RB sets may be determined from a plurality of RB sets in the unlicensed band by performing a plurality of sensing procedures in the plurality of RB sets.

In some implementations, the group of RB sets may be empty in an event that at least one RB set of the plurality of RB sets fails a corresponding sensing procedure.

In some implementations, each RB set in the group of RB sets may be associated with a successful sensing procedure.

In some implementations, process 500 may further involve processor 332 receiving at least one of: (1) information of sensing procedure result for the plurality of RB sets: (2) information of successful sensing procedure; and (3) information of power for energy detection.

In some implementations, the first reference signal and the second reference signal may be received in a same time slot.

In some implementations, the first reference signal and the second reference signal may be associated with a multi-port sounding reference signal. The first reference signal may be associated with a first port number. The second reference signal may be associated with a second port number. The multi-port sounding reference signal may be associated with a third port number. A sum of the first port number and the second port number may be equal to the third port number.

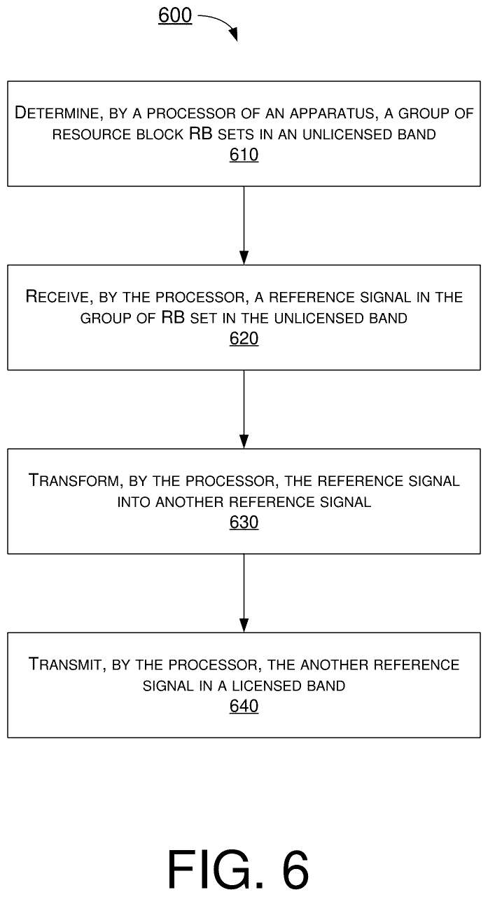

FIG. 6 illustrates an example process 600 in accordance with an implementation of the present disclosure. Process 600 may be an example implementation of above scenarios/schemes, whether partially or completely, with respect to transmitting RS associated with unlicensed band in mobile communications of the present disclosure. Process 600 may represent an aspect of implementation of features of communication apparatus 320. Process 600 may include one or more operations, actions, or functions as illustrated by one or more of blocks 610 to 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 320 or any suitable communication device or machine type devices. Solely for illustrative purposes and without limitation, process 600 is described below in the context of communication apparatus 320. Process 600 may begin at block 610.

At block 610, process 600 may involve processor 322 of communication apparatus 320 determining a group of resource block RB sets in an unlicensed band. Process 600 may proceed from block 610 to block 620.

At block 620, receiving a reference signal in the group of RB sets in the unlicensed band. Process 600 may proceed from block 620 to block 630.

At block 630, process 600 may involve processor 322 transforming the reference signal into another reference signal. Process 600 may proceed from block 630 to block 640.

At block 640, process 600 may involve processor 322 transmitting the another reference signal in a licensed band.

In some implementations, process 600 may further involve processor 322 determining the group of RB set from a plurality of RB sets in the unlicensed band by performing a plurality of sensing procedures in the plurality of RB sets.

In some implementations, the group of RB set may be empty in an event that one RB set of the plurality of RB sets fails a corresponding sensing procedure.

In some implementations, each RB set in the group of RB set may be associated with a successful sensing procedure.

In some implementations, process 600 may further involve processor 322 receiving at least one of: (1) information of sensing procedure result for the plurality of RB sets: (2) information of successful sensing procedure; and (3) information of power for energy detection.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a group of resource block (RB) sets in an unlicensed band;
transmitting, by the processor, a first reference signal in a licensed band; and
transmitting, by the processor, a second reference signal in the group of RB sets, wherein the first reference signal is associated with the second reference signal.

2. The method of claim 1, wherein determining the group of RB sets in the unlicensed band further comprises:
determining, by the processor, the group of RB sets from a plurality of RB sets in the unlicensed band by performing a plurality of sensing procedures in the plurality of RB sets.

3. The method of claim 2, wherein the group of RB sets is determined to be empty in an event that at least one RB set of the plurality of RB sets fails a corresponding sensing procedure.

4. The method of claim 2, wherein each RB set in the group of RB sets is associated with a successful sensing procedure.

5. The method of claim 1, further comprising:
transmitting, by the processor, at least one of:
information of sensing procedure result for the plurality of RB sets;
information of successful sensing procedure; and
information of power for energy detection.

6. The method of claim 1, wherein the first reference signal and the second reference signal are transmitted in a same time slot.

7. The method of claim 1, wherein the first reference signal and the second reference signal are associated with a multi-port sounding reference signal.

8. The method of claim 7, wherein the first reference signal is associated with a first port number, the second reference signal is associated with a second port number, the multi-port sounding reference signal is associated with a third port number, and a sum of the first port number and the second port number is equal to the third port number.

9. A method, comprising:
receiving, by a processor of an apparatus, a first reference signal from a first device in a licensed band; and
receiving, by the processor, a second reference signal from a second device in the licensed band, wherein the second reference signal is transmitted from the first device via a group of RB sets of an unlicensed band and forwarded from the second device in the licensed band, and the first reference signal is associated with the second reference signal.

10. The method of claim 9, wherein the group of RB sets is determined from a plurality of RB sets in the unlicensed band by performing a plurality of sensing procedures in the plurality of RB sets.

11. The method of claim 10, wherein the group of RB sets is empty in an event that at least one RB set of the plurality of RB sets fails a corresponding sensing procedure.

12. The method of claim 10, wherein each RB set in the group of RB sets is associated with a successful sensing procedure.

13. The method of claim 9, further comprising:
receiving, by the processor, at least one of:
information of sensing procedure result for the plurality of RB sets;
information of successful sensing procedure; and
information of power for energy detection.

14. The method of claim 9, wherein the first reference signal and the second reference signal are received in a same time slot.

15. The method of claim 9, wherein the first reference signal and the second reference signal are associated with a multi-port sounding reference signal, the first reference signal is associated with a first port number, the second reference signal is associated with a second port number, the multi-port sounding reference signal is associated with a third port number, and a sum of the first port number and the second port number is equal to the third port number.

16. A method, comprising:
determining, by a processor of an apparatus, a group of resource block RB sets in an unlicensed band;
receiving, by the processor, a reference signal in the group of RB sets in the unlicensed band;
transforming, by the processor, the reference signal into another reference signal; and
transmitting, by the processor, the another reference signal in a licensed band.

17. The method of claim 16, wherein determining the group of RB sets in the unlicensed band further comprises:
determining, by the processor, the group of RB sets from a plurality of RB sets in the unlicensed band by performing a plurality of sensing procedures in the plurality of RB sets.

18. The method of claim 17, wherein the group of RB sets is empty in an event that one RB set of the plurality of RB sets fails a corresponding sensing procedure.

19. The method of claim 17, wherein each RB set in the group of RB sets is associated with a successful sensing procedure.

20. The method of claim 16, further comprising:
transmitting, by the processor, at least one of:
information of sensing procedure result for the plurality of RB sets;
information of successful sensing procedure; and
information of power for energy detection.
